(19) United States
(12) Patent Application Publication
(10) Pub. No.: US 2024/0149944 A1
(43) Pub. Date: May 9, 2024

(54) SENSOR DEVICE IN A STEERING SYSTEM OF A MOTOR VEHICLE, AND STEERING SYSTEM

(71) Applicant: ZF Automotive Germany GmbH, Alfdorf (DE)

(72) Inventors: Eduard Span, Koeln (DE); Rainer Engel, Krefeld (DE); Heinz-Dieter Heitzer, Heinsberg (DE)

(21) Appl. No.: 18/501,397

(22) Filed: Nov. 3, 2023

(30) Foreign Application Priority Data
Nov. 9, 2022 (DE) 10202221 1830.8

(51) Int. Cl. B62D 15/02

(52) U.S. Cl. CPC B62D 15/0225

(57) ABSTRACT

A steering system of a motor vehicle comprises a sensor device comprising a rotational angle sensor, which is connected to a toothed wheel and detects a rotation of the toothed wheel is disclosed. The toothed wheel is fitted on a steering tie rod such that it meshes with a spindle thread on the steering tie rod which is part of a ball screw drive of a servo drive of the steering system.

### CROSS-REFERENCE TO RELATED APPLICATION

This application claims priority to German Priority Application No. 102022211830.8, filed Nov. 9, 2022, the disclosure of which is incorporated herein by reference in its entirety.

### TECHNICAL FIELD

The disclosure relates to a sensor device in a steering system of a motor vehicle and to a steering system of a motor vehicle.

### BACKGROUND

Conventionally, a displacement travel of a steering tie rod in the steering system of a motor vehicle is determined using a steering angle sensor, which alternatively detects the angular position of the steering column. The steering column is conventionally connected to a pinion, which, together with a toothed-rack portion of the steering tie rod, forms a toothed-rack steering gear. However, steering systems in which the steering tie rod is moved in principle via an electric servo drive comprising a ball screw drive are increasingly being developed, with there being no direct mechanical connection between the steering wheel and the steering tie rod (steer-by-wire principle).

### SUMMARY

What is needed is a straightforward and cost-effective detection of the displacement travel of the steering tie rod even for such steering systems.

A sensor device in a steering system of a motor vehicle is proposed in which, the sensor device comprises a rotational angle sensor, the rotational angle sensor being connected to a toothed wheel and detecting a rotation of the toothed wheel. The toothed wheel is fitted on a steering tie rod such that it meshes with a spindle thread on the steering tie rod which is part of a ball screw drive of a servo drive.

In this way, the sensor device is directly coupled to the spindle thread of the servo drive, which is used directly to operate the steering system. Components which are omitted in steer-by-wire solutions, such as a toothed rack portion, are no longer required for determination of the steering angle. Moreover, the direct contact of the toothed wheel with the spindle thread allows the rotational angle sensor to more precisely determine the absolute position of the steering tie rod and thus of the displacement travel of the steering tie rod. The rotation of the toothed wheel can be easily transmitted directly to the rotational angle sensor, this improving measurement accuracy.

The toothed wheel is for example a pinion or a worm gear. In this configuration, the toothed wheel can have a robust and space-saving design.

If the toothed wheel meshes with the spindle thread at a 90° angle, the sensor device can be arranged on the steering tie rod in space-saving fashion.

A compact structure is produced for example in that the rotational angle sensor is connected directly to a shaft which also bears the toothed wheel.

In order to as far as possible reduce wear of the spindle thread that is caused by the toothed wheel, the toothed wheel can consist of a plastic. For example, a suitable polyurethane can be used.

In one exemplary arrangement, a radially elastically flexible element which acts on the connection between the toothed wheel and the spindle thread is present. The radially elastically flexible element ensures, among other things, a constant contact pressure of the toothing of the toothed wheel against the spindle thread and thus good contact between the toothed wheel and the spindle thread. It is thus possible to obtain a practically play-free engagement of the toothed wheel in the spindle thread, this increasing the measurement accuracy.

For example, the toothed wheel is radially flexible in relation to the spindle thread.

The radially elastically flexible element can be integrated in the toothed wheel, for example by virtue of a suitable geometric structure or a suitable combination of different materials in the toothed wheel.

In one exemplary arrangement, the radially elastically flexible element may comprise curved spokes between a hub and a toothed ring of the toothed wheel. The toothed wheel may be, for example in a subregion of the toothed wheel or the spokes of the toothed wheel, in the form of the radially elastic element. Such a radially elastically flexible element, which may be curved spokes, can be molded into the toothed wheel, for example directly when the latter is being produced.

In another variant, the radially elastically flexible element comprises an elastic intermediate piece between the hub and the toothed ring of the toothed wheel. The elastic intermediate piece includes, for example, of a softer material than the hub and/or the toothed ring of the toothed wheel. The production of such a toothed wheel is possible for example in an injection molding process, during which various materials are injected into a mold.

As an alternative or in addition to a specific design, described above, of the toothed wheel, the shaft may be received in at least one radially flexible mount which forms the radially elastically flexible element. The radially flexible mount can for example be achieved in that at least one component of the mount includes a radially flexible material, for instance an elastomer. It is also possible to achieve the radial flexibility by virtue of the geometric shape of a component of the mount that allows a certain tilting of the shaft. As a result, a radial flexibility for adapting the radial position of the shaft and thus of the toothed wheel is enabled. For example, the mount may comprise a spherical shell which can move through a certain angular range. Different variants can be combined in the radially flexible mount of the shaft, for example a mount with a spherical shell and a mount with an elastomer component on opposite sides of the toothed wheel.

A steering system of a motor vehicle comprising a sensor device described above is also disclosed and within the scope of the disclosure.

In one exemplary arrangement, a housing of the sensor device is arranged next to and connected in one piece to a housing of the ball screw drive of the servo drive in order to make optimum use of the installation space on the steering tie rod. The positioning and fixing of the housing also make it possible to realize a rotation prevention arrangement of the sensor device.

The sensor device can include the housing, the shaft, the mount of the shaft in the housing, the toothed wheel arranged on the shaft, the rotational angle sensor coupled to the shaft, and a plug for the electrical and electronic contact-connection of the rotational angle sensor.

### BRIEF DESCRIPTION OF DRAWINGS

The disclosure will be described in more detail below on the basis of two exemplary arrangements with reference to the appended figures, in which:

FIG. 1 shows a schematic perspective illustration of a steering system according to the disclosure of a vehicle comprising a sensor device according to the disclosure as per a first exemplary arrangement;

FIG. 2 shows a schematic sectional view of the sensor device from FIG. 1;

FIG. 3 shows a schematic perspective illustration, in partial section, of the engagement of the toothed wheel of the sensor device in a spindle thread of a steering tie rod of the steering system from FIG. 1;

FIG. 4 shows a schematic perspective illustration of the sensor device from FIG. 2;

FIGS. 5 to 7 show schematic perspective illustrations of components of the sensor device from FIG. 1;

FIG. 8 shows a schematic sectional view of different variants of a toothed wheel of the sensor device from FIG. 1;

FIG. 9 shows a schematic sectional view of a sensor device according to the disclosure as per a second exemplary arrangement; and

FIG. 10 shows a schematic perspective illustration of the toothed wheel and the spindle thread from FIG. 9.

### DETAILED DESCRIPTION

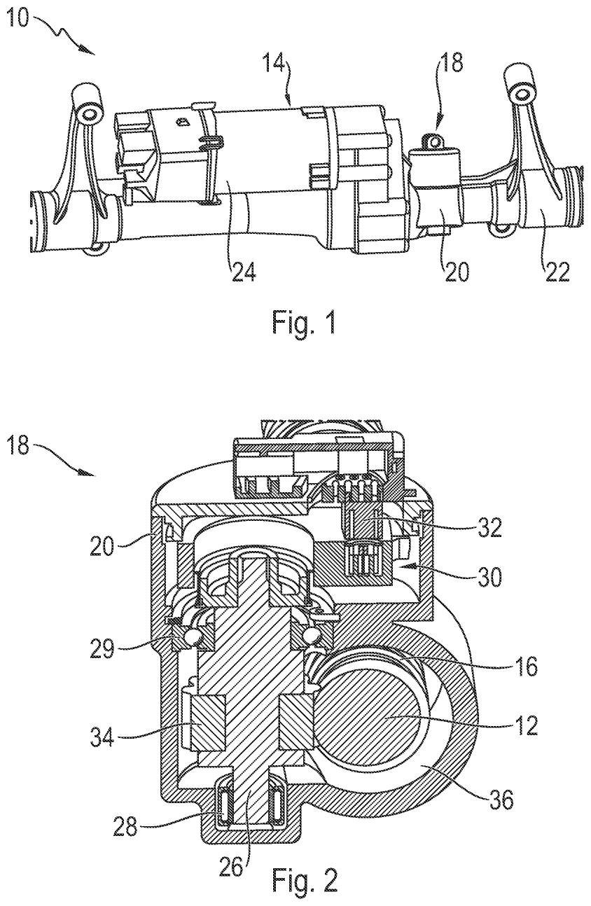

FIG. 1 shows a steering system 10 of a motor vehicle, comprising a steering tie rod 12 (see, for example, FIGS. 2 to 4) and an electric servo drive 14 acting on the steering tie rod 12.

Steering movement of the vehicle is achieved purely by actuation of an electric motor of the servo drive 14 here (steer-by-wire). The servo drive 14 comprises a known ball screw drive (not illustrated in more detail), which can move the steering tie rod 12 linearly depending on a desired displacement travel of the steering tie rod. A ball screw drive comprises a spindle thread 16 on the steering tie rod 12, via which a nut of the ball screw drive acts on the steering tie rod 12.

The steering tie rod 12 is suitably secured against rotation and can therefore only be displaced linearly.

A current position of the steering tie rod 12 that correlates to a current steering angle of the steering system is detected by a sensor device 18.

The sensor device 18 comprises a housing 20, which here is rotationally fixedly arranged on a steering housing 22 and is for example formed in one piece with the steering housing 22. The sensor device 18 is in this example is positioned directly next to a housing 24 of the servo drive 14. The housing 20 is formed in one piece with the housing 24 here, too.

FIG. 2 shows the sensor device 18 in section. A shaft 26, which is rotatably mounted at one end in a mount 28 formed in the housing 20, is received in the housing 20.

Underneath its opposite end, the shaft 26 extends through a second mount 29.

Above the mount 29, the end of the shaft 26 is suitably connected to a suitable rotational angle sensor 30, to which a rotational movement of the shaft 26 is transmitted and which detects the rotational movement of the shaft 26 and converts it into a rotational angle, or a current steering angle. In this example, the rotational angle sensor 30 is plugged onto the shaft 26.

The data ascertained by the rotational angle sensor 30 are transferred to a suitable control unit (not illustrated) of the steering system 10 via a plug 32 and a line (not illustrated) connected thereto.

On the shaft 26, a toothed wheel 34 is arranged between the mounts 28, 29 for conjoint rotation. It is possible to form the toothed wheel 34 in one piece with the shaft 26.

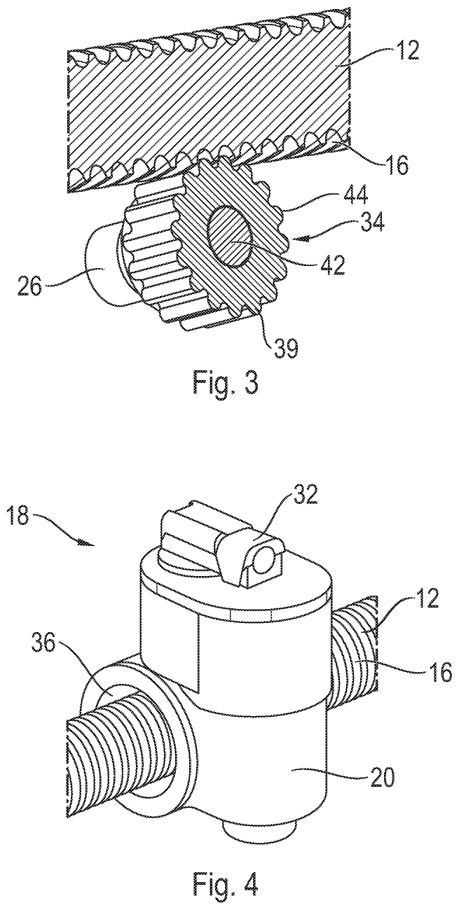

FIG. 3 shows the toothed wheel 34 in engagement with the spindle thread 16 on the steering tie rod 12. The toothed wheel 34 is a worm gear or a pinion here and in this example has approximately the same diameter as the steering tie rod 12.

The toothed wheel 34 meshes with the spindle thread 16 of the steering tie rod 12 and in this example is arranged at a 90° angle in relation to the steering tie rod 12. A displacement of the steering tie rod 12 is thus converted directly into a rotation of the toothed wheel 34 and the shaft 26 fixedly connected thereto, and is transmitted directly to and detected by the rotational angle sensor 30.

The housing 20 is designed such that it has a through-opening 36 for the steering tie rod 12 between the mounts 28, 29.

Here, in a compact form, the housing 20 encloses the shaft 26, the toothed wheel 34 and the rotational angle sensor 30.

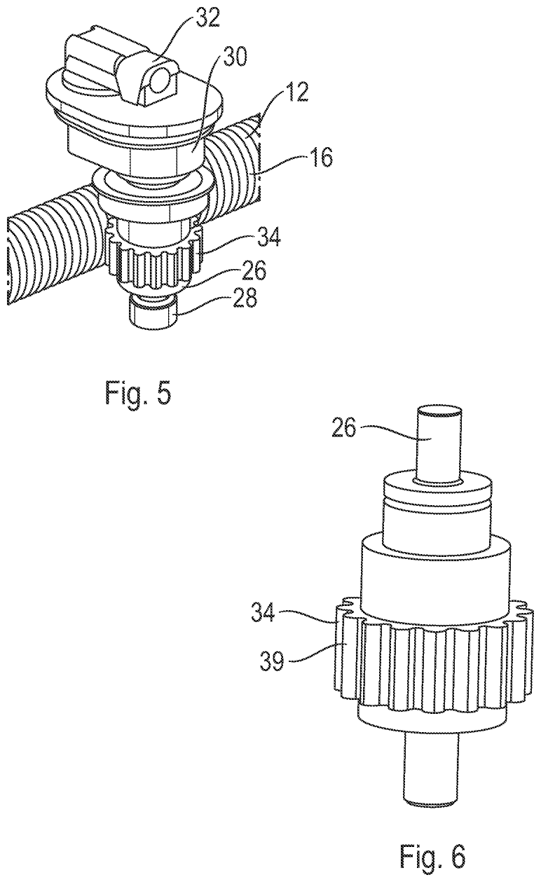

FIG. 4 shows how the steering tie rod 12 extends through the through-opening 36 in the housing 20 of the sensor device 18. FIG. 5 illustrates the engagement of the toothed wheel 34 in the spindle thread 16 of the steering tie rod 12.

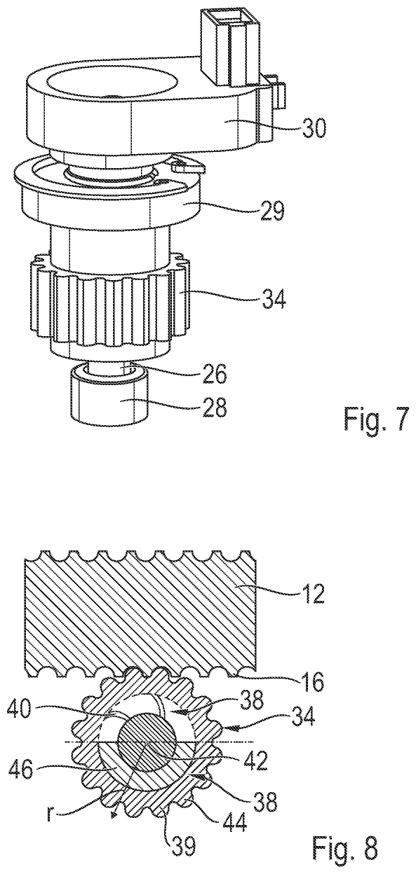

FIG. 6 shows the arrangement of the toothed wheel 34 on the shaft 26 in more detail, and FIG. 7 shows the attachment of the rotational angle sensor 30 to the shaft 26.

Here, the shaft 26 has multiple radial projections, which serve among other things to axially position the rotational angle sensor 30 that is placed on the shaft 26.

A radially elastically flexible element 38 acts between the housing 20 and the spindle thread 16 of the steering tie rod 12 and in particular on the teeth 39 of the toothed wheel 34 and ensures an at least virtually play-free engagement of the teeth 39 of the toothed wheel 34 in the spindle thread 16.

In this example, the toothed wheel 34 consists of plastic and thus of a softer material than the metal of the steering tie rod 12 and the spindle thread 16. Therefore, the entire toothed wheel 34 can act as radially elastically flexible element 38.

FIG. 8 shows two further variants in which a radially elastically flexible element 38 is integrated in the toothed wheel 34, with the result that the toothed wheel 34 is flexible to a certain degree in the radial direction r. This likewise ensures that the toothed wheel 34 is elastically flexible at least in the radial direction r.

In the upper half of the toothed wheel 34 in FIG. 8, there is shown a radially elastically flexible element 38 which includes multiple curved spokes 40 connecting a hub 42 of the toothed wheel 34 to a toothed ring 44 of the toothed wheel 34. Here, the elastic flexibility results from the geometric shape of the spokes 40 (which of course are distributed evenly around the entire circumference of the toothed wheel 34). The entire toothed wheel 34 therefore includes the same plastics material in this variant.

In the lower half of the toothed wheel 34 in FIG. 8, there is illustrated a radially elastically flexible element 38 which includes a radially elastic intermediate piece 46 arranged around the circumference between the hub 42 and the toothed ring 44. The intermediate piece 46 consists for example of a softer and/or more elastic plastic than the hub 42 and the toothed ring 44 do. For example, the toothed wheel 34 in this variant is manufactured in an injection molding process, during which the intermediate piece 46 is injected between the hub 42 and the toothed ring 44.

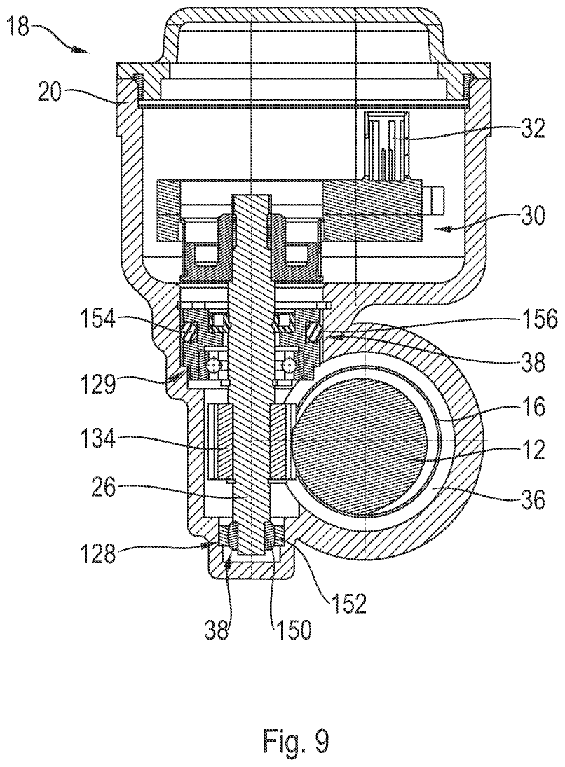

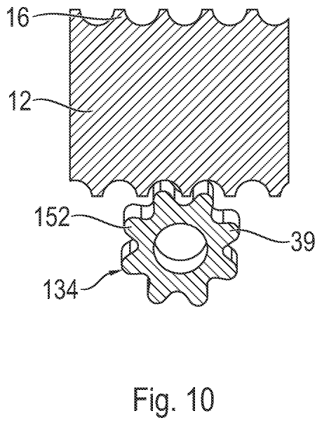

FIGS. 9 and 10 show a second exemplary arrangement of the sensor device 18.

Identical or similar components that are already known continue to be denoted by the reference signs already introduced or are denoted by numbers increased by 100.

The essential difference in relation to the first exemplary arrangement is that the toothed wheel 34 here can also have a radially rigid configuration, while the radially elastically flexible element 38 is realized by a radially flexible design of the mount 128 and optionally of the mount 129 of the shaft 26.

Naturally, it would also be conceivable to additionally also equip the toothed wheel 34 with a radially elastically flexible element 38.

In this example, the mount 128 comprises a spherical bearing shell 150, which enables tilting of the shaft 26 and thus a certain radial movement of the shaft 26. Optionally, the bearing shell 150 consists of a suitable elastically flexible material, and therefore moreover a radial flexibility is achieved by virtue of elastic deformation of the bearing shell 150. In addition, the mount 128 may comprise a further radially elastically deformable component 152 which for example radially surrounds the bearing shell 150 and supports it against the housing 20 (see FIG. 9).

The mount 129 in this example has a radially flexible elastic seal 154. In this case, the seal 154 is an elastic O-ring which is arranged between an outer side of the mount 129 and an inner side of the housing 20, for example in a groove 156 in the outer side of the mount 129. The mount 129 therefore elastically yields upon a radial movement and tilting of the shaft 26.

In this way, this radially elastically flexible element 38 brings about a play-free connection of the toothed wheel 134 to the spindle thread 16.

The toothed wheel 134 is shown in more detail in FIG. 10 and here has a total of eight rounded teeth 39.

For reasons of clarity, all identical components are not always provided with reference signs in the figures.

1. A sensor device in a steering system of a motor vehicle, comprising a rotational angle sensor, the rotational angle sensor being connected to a toothed wheel and detecting a rotation of the toothed wheel, the toothed wheel being fitted on a steering tie rod such that it meshes with a spindle thread on the steering tie rod which is part of a ball screw drive of a servo drive.

2. The sensor device as claimed in claim 1, wherein the toothed wheel meshes with the spindle thread at a 90° angle in relation to the steering tie rod.

3. The sensor device as claimed in claim 1, wherein the rotational angle sensor directly connects to a shaft that also bears the toothed wheel.

4. The sensor device as claimed in claim 1, wherein the toothed wheel is constructed of a plastic.

5. The sensor device as claimed in claim 1, wherein a radially elastically flexible element which acts on a connection between the toothed wheel and the spindle thread being present.

6. The sensor device as claimed in claim 5, the toothed wheel being radially flexible in relation to the spindle thread.

7. The sensor device as claimed in claim 5, the radially elastically flexible element being integrated in the toothed wheel.

8. The sensor device as claimed in claim 7, the radially elastically flexible element comprising curved spokes or an elastic intermediate piece between a hub and a toothed ring of the toothed wheel.

9. The sensor device as claimed in claim 5, the shaft being received in at least one radially flexible mount which forms the radially elastic flexible element.

10. A steering system for a motor vehicle, comprising a sensor device as claimed in claim 1.

11. The steering system as claimed in claim 10, a housing of the sensor device being arranged next to and formed in one piece with a housing of the ball screw drive of the servo drive.

12. The sensor device as claimed in claim 2, wherein the rotational angle sensor directly connects to a shaft that also bears the toothed wheel.

13. The sensor device as claimed in claim 12, wherein a radially elastically flexible element which acts on a connection between the toothed wheel and the spindle thread being present.

14. The sensor device as claimed in claim 6, the radially elastically flexible element being integrated in the toothed wheel.
